(19) United States
(12) Patent Application Publication
(10) Pub. No.: US 2013/0176359 A1
(43) Pub. Date: Jul. 11, 2013

(54) PRINT HEAD CLEANING COMPOSITION AND METHOD FOR CLEANING PRINT HEAD USING SAME

(71) Applicants: Mark Colby ROBERTS, San Clemente, CA (US); Vladimir GALENTOVSKY, Oakville (CA)

(72) Inventors: Mark Colby ROBERTS, San Clemente, CA (US); Vladimir GALENTOVSKY, Oakville (CA)

(21) Appl. No.: 13/346,555

(22) Filed: Jan. 9, 2012

(51) Int. Cl. B41J 2/165; C11D 3/60

(52) U.S. Cl. 347/28; 510/170

(57) ABSTRACT

An ink-like cleaning solution for cleaning an inkjet print head installed in an inkjet printer and having deposits of ink, includes: a viscosity agent for adjusting the viscosity of the ink-like cleaning solution; a surfactant for adjusting the surface tension of the ink-like cleaning solution; a cleaning agent for breaking down the deposits of ink; and a solvent miscible with the ink, in which the viscosity agent, the surfactant, and the cleaning agent are dissolved or dispersed. The viscosity and the surface tension of the ink-like cleaning solution are equivalent to those of the ink used for printing with the inkjet print head such that the inkjet print head can print on a media using the ink-like cleaning solution under conditions for printing.

### BACKGROUND OF THE INVENTION

1. Field of the Invention

The present invention generally relates to technology of print head cleaning, particularly to a print head cleaning composition and a method for cleaning a print head using the same.

2. Description of the Related Art

Ink jet printers use printing ink to place dots for recording on a media. Ink is often formulated for user convenience or to be user friendly. For example, ink is formulated so as to be quickly dried, able to stick to many different types of media, and eco-friendly (environmentally or ecologically safe). However, these user friendly modifications make ink more susceptible to adhesion, coagulation, and solidification on an inner wall of the ink channels, causing partial clogging of nozzle openings and ink channels of print heads. Many print heads are equipped with print head cleaning mechanisms such as a wiper blade for cleaning nozzle surfaces (e.g., U.S. Pat. No. 6,241,337). Although the nozzle surfaces are relatively easy to clean, through repeated use of the print heads, deposition of ink inside ink channels of print heads continues and eventually reaches a point where nozzles are clogged or ink flow is deflected.

Some inkjet printers are provided with cleaning devices for removing clogs from ink channels of print heads. U.S. Pat. No. 7,604,327 discloses an ink jet printer including two ink channels which are independent from each other wherein an ink ejection mode and an ink circulation mode are switched using the two ink channels. In the ink circulation mode, ink circulates and clogs inside the ink channels can be removed. However, it is difficult to remove solidified ink at the nozzle openings where ink does not circulate, and significant modifications to print heads, a sophisticated cleaning system and equipment are required. Further, since ink itself is used for removing deposited ink, it is difficult to clean the inner walls of the ink channels. U.S. Pat. No. 7,874,636 discloses a cleaning system to clean a print head of an inkjet printer using solvent flow and suction. However, since solvent flow near a surface of inner walls of the ink channels is slow, and it may not be sufficient to remove ink deposition adhered to the surface of the inner walls. U.S. Pat. No. 7,506,955 discloses a cleaning ejection apparatus having a pressurization device which generates pressurization force to forcibly eject ink, thereby removing a clog from the ink channels. However, significant modifications to print heads, a sophisticated controlling system and equipment are required. Further, since ink itself is used for removing deposited ink, it is difficult to clean the inner walls of the ink channels. The conventional methods and systems of cleaning can unclog small clogs or deflections which are formed in a short term, but they do not remove large clogs and dried deposits formed by extended use or non use.

When clogs are not successfully removed by the printer cleaning functions, the print head must be refurbished or replaced with a new one. The print head itself has a relatively long life, but user friendly ink causes its life to be cut short.

Any discussion of problems and solutions involved in the related art has been included in this disclosure solely for the purposes of providing a context for the present invention, and should not be taken as an admission that any or all of the discussion were known at the time the invention was made.

### SUMMARY OF THE INVENTION

Some embodiments provide an ink-like cleaning solution for cleaning an inkjet print head installed in an inkjet printer and having deposits of ink, comprising: (a) at least one viscosity agent for adjusting the viscosity of the ink-like cleaning solution; (b) at least one surfactant for adjusting the surface tension of the ink-like cleaning solution; (c) at least one cleaning agent for breaking down the deposits of ink; and (d) at least one solvent miscible with the ink, in which the viscosity agent, the surfactant, and the cleaning agent are dissolved or dispersed, wherein the viscosity and the surface tension of the ink-like cleaning solution are equivalent to those of the ink used for printing with the inkjet print head such that the inkjet print head can print on a media using the ink-like cleaning solution under conditions for printing. The ink-like cleaning solution is also referred to as the cleaning solution or cleaner. In some embodiments, the viscosity and surface tension of the ink-like cleaning solution are substantially the same as those of the ink. In some embodiments, components (a), (b), (c), and (d) are mutually exclusive.

In some embodiments, the ink-like cleaning solution further comprises a dye for indicating printing results on the media. In some embodiments, the ink-like cleaning solution consists essentially of the at least one viscosity agent, the at least one surfactant, the at least one cleaning agent, the at least one solvent, and the dye.

In some embodiments, the viscosity and surface tension are equivalent to those of the ink selected from the group consisting of water-based ink, solvent ink, eco-solvent ink, UV ink, and T-shirt ink.

In some embodiments, the cleaning agent is selected from the group consisting of dichloromethane, dimethyl sulfoxide (DMSO), and N-methyl-2-pyrrolidone. In some embodiments, the viscosity agent is selected from the group consisting of diethylene glycol and propylene glycol. In some embodiments, the surfactant is selected from the group consisting of 2-butoxyethanol, ethoxylated fatty ethyl alcohol, and fatty alkyl aminomide.

In some embodiments, the ink-like cleaning solution further comprises a buffer agent for controlling the pH of the cleaning solution.

In some embodiments, the ink-like cleaning solution is substantially free of humectants which keep the solution from evaporating and of adhesion promoters which promote droplets from the print head to stick to a media.

In some embodiments, the ink-like cleaning solution is stored in a cartridge adapted to be plugged into the printer as if the cartridge is an ink cartridge.

Some embodiments provide a container containing any suitable ink-like cleaning solution disclosed herein.

In some embodiments, the container is provided with an ink chip which is a circuit board communicating with a printer control unit to provide the printer control unit with information corresponding to ink type, color, and/or volume information.

In some embodiments, the container is a cartridge adapted to be plugged into a printer.

In some embodiments, the container is provided with an ink chip which is a circuit board attached to the container and communicating with a printer control unit to provide the printer control unit with information corresponding to ink type, color, and/or volume information.

Some embodiments provide a method for cleaning of an inkjet print head having deposits of ink, comprising: (I) providing any suitable ink-like cleaning solution disclosed herein which has a viscosity and surface tension equivalent to those of the ink; (II) supplying the ink-like cleaning solution to at least one nozzle of the print head which is in need of cleaning due to deposits of ink; and (iii) causing the ink-like cleaning solution to pass through the nozzle under conditions equivalent to those for printing, thereby cleaning the nozzle.

Some embodiments provide a method for in-situ cleaning of an inkjet print head installed in an inkjet printer and having deposits of ink, comprising: (i) identifying at least one nozzle of the print head which is in need of cleaning due to deposits of ink; (ii) after discontinuing a supply of ink to the nozzle, providing any suitable ink-like cleaning solution disclosed herein which has a viscosity and surface tension equivalent to those of the ink; (iii) supplying the ink-like cleaning solution to the nozzle without removing the print head from the printer; and (iv) causing the ink-like cleaning solution to pass through the nozzle under conditions equivalent to those for printing, thereby cleaning the nozzle.

In some embodiments, the method further comprises, after step (iv), printing an image on a medium using the ink-like cleaning solution to determine whether cleaning is complete, wherein the ink-like cleaning solution contains a dye.

In some embodiments, the method further comprises, prior to step (iii), (v) setting an ink chip for printing using the ink-like cleaning solution, which ink chip is a circuit board communicating with a printer control unit to provide the printer control unit with information corresponding to ink type, color, and/or volume information; and (vi) causing the printer control unit to accept the ink chip so as to allow printing.

In some embodiments, the method further comprises, after step (iv), (vii) determining whether cleaning is complete, and (viii) if it is not complete, repeating steps (iii) and (iv).

In some embodiments, step (iv) is repeated after changing frequency and/or volume of the ink-like cleaning solution ejected from the print head.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a flow chart illustrating a cleaning method according to an embodiment of the present invention.

FIG. 2 is a flow chart illustrating a part of the cleaning method according to an embodiment of the present invention.

### DETAILED DESCRIPTION OF EMBODIMENTS

In this disclosure, the terms are defined as follows unless defined otherwise in other embodiments. However, any defined meanings do not necessarily exclude ordinary and customary meanings in some embodiments.

The term “ink jet print head” refers to a self contained device for precisely placing ink dots (droplets) on a media. The term “nozzles” refers to individually addressable ejecting or firing mechanisms that fire individual dots of ink. Print heads have banks of these nozzles to fire dots of ink on a media. The term “clogged nozzle” refers to a nozzle having deposits inside inhibiting it from ejecting ink dots. The term “deflected nozzle” refers to a nozzle which is not clogged but has deposits inside which keep ink dots from ejecting straight or which deflect the direction of ejecting ink dots. The print quality suffers when the print head is not placing dots precisely on the media. The term “cleaning solvent” refers to a liquid for cleaning which has a lower viscosity than ink, is compatible or miscible with ink, and can be pumped or sucked through nozzles. The solvent includes, but is not limited to, organic solvents and water. The term “deposit” refers to ink or at least one of its components that has coagulated on a surface and adversely affects ink flow over the surface and in or about the ejection mechanism. The term “purging nozzle” refers to forcing ink or cleaning solvent through the nozzle for removing deposits and improving the quality of a print. The term “nozzle plate” refers to a part of the print head where ink dots exit from the print head to hit a media. The term “ink cartridge” refers to a portable container of ink which is configured to be detachably plugged into the printer for replacing ink supply. The term “bulk ink” refers to ink available in large volumes which can be added to an external ink feeding system which acts as an extended ink supply. The term “ink chip” refers to a circuit board which is typically attached to an ink cartridge and communicates with a printer control unit to provide the printer with the ink type, color, and volume information, etc. Most printers do not work without the correct chip installed on the ink cartridge. The term “viscosity” refers to a measure of the flow resistance of a fluid which is being deformed by either shear stress or tensile stress. Inks have a specific viscosity which allows the inks to work in the ejection mechanism of the print head. The term “surface tension” refers to a property of the surface of a liquid that allows it to resist against an external force applied on the surface. Inks have a specific surface tension which allows the inks to work in the ejection mechanism of the print head. The term “RIP” refers to Raster Image Processor which is a software driver used by a printer to turn images and text into ink jet dots which are printed by the printer. The term “DPI” refers to Dots per Inch which relates to the number of ink dots in an inch. This is the rating of the print quality or modes of a printer. The term “firing frequency” refers to a frequency representing how fast dots are fired from the print head nozzles. In some embodiments, the firing frequency can be controlled by using different DPI settings or different modes. The term “droplet size” refers to the volume of ink droplet that is fired from the nozzle plate. In some embodiments, the droplet size can be controlled by the RIP or a software program. The term “platen” refers to a physical surface where a media sits. In some embodiments, the platen can be a roller, belt, or stationary platform. The term “nozzle test” refers to a test representing a printer function which shows a user which nozzles are firing properly on a print head. In some embodiments, it shows a user which nozzles are functioning and sometimes whether the nozzles deflect the directions of ejecting ink. The term “calibration” refers to a process that a printer uses to align dots of each print head so that the print quality can be the highest possible. If a print head is replaced, a recalibration is necessary. In some embodiments, the recalibration takes hours and must be done by a trained technician.

In the present disclosure where conditions and/or structures are not specified, the skilled artisan in the art can readily provide such conditions and/or structures, in view of the present disclosure, as a matter of routine experimentation. Also, in the present disclosure including the examples described later, the specific numbers may refer to approximate numbers (e.g., with “about”) and include equivalents, and may refer to average, median, representative, majority, etc., and the ranges applied in some embodiments may include or exclude the lower and/or upper endpoints. Further, “a” refers to a species or a genus including multiple species.

In the disclosure, “substantially smaller”, “substantially different”, “substantially less” or the like may refer to a material difference or a difference recognized by a skilled artisan such as those of at least 1%, 5%, 10%, 20%, 30%, 40%, 50%, 60%, 70%, 80%, or any ranges thereof in some embodiments. Also, in the disclosure, “substantially the same”, “substantially uniform”, or the like may refer to an immaterial difference or a difference recognized by a skilled artisan such as those of less than 20%, 10%, 5%, 1%, or any ranges thereof in some embodiments.

There are multiple ink jet types which are classified based on the ink ejection mechanism, which include, but are not limited to, two major technologies applicable to some embodiments. The first mechanism is the piezo technology which uses a vibrating crystal and a chamber which changes its shape and forces a droplet of ink to be ejected or fired from the nozzle. The second mechanism is the thermal jet (bubble jet) technology which heats a small amount of ink at the nozzle plate forming a bubble which explodes creating a droplet which exits from the nozzle plate and hits a media. The above two technologies are used by many manufacturers for desktop, large format, and grand format printers. Some embodiments are applicable to any ink jet printer which comprises a print head having nozzles with nozzle plates, a platen, and an RIP and receives ink cartridges with ink chips or has a bulk ink system, wherein the RIP obtains information provided from the ink chips or provided through an interface and performs proper printing on a media based on the obtained DPI, firing frequency, droplet size, etc. Typically, the printer is capable of performing a nozzle test to indicate the operating conditions of each nozzle. Also, typically, the printer is capable of performing a calibration prior to performing actual printing. Through extended use or non use of a printer, ink deposits are formed in the nozzles and ink channels and built up, and the nozzles of the print head become clogged or the ink flow is deflected. When the nozzles are clogged or ink flow deflected, the nozzles are purged using a cleaning solvent without replacing the print head, according to some embodiments.

Some embodiments are applicable to an inkjet printer using an ink type including, but not limited to, water-based ink, solvent ink, eco-solvent ink, UV ink, T-shirt ink, or other specialized ink including chemical deposits. In some embodiments, chemical deposits are applicable to laboratory testing markers/chemicals printed on specialized media, such as those used for pregnancy tests, blood tests, etc. In some embodiments, chemical deposits are etching chemicals or resist printed on a substrate for integrated circuits. One of ordinary skill in the art could readily appreciate that the disclosed cleaning solutions can be modified for any types of ink based on the present disclosure without undue burden. Inks typically contain a solvent, pigment, drying agents, humectants (to keep ink components from evaporating), surfactants, adhesion promoters, viscosity agents, and other proprietary additives. Any of these components can cause a clog along with the pigment. In some embodiments, the ink-like cleaning solutions do not contain most of these components, and particularly are substantially free of humectants and adhesion promoters. In some embodiments, the ink-like cleaning solutions contain humectants (such as 2-pyrrolidone) to the extent that they do not cause clogs (e.g., in an amount of about 5% to about 25% relative to the cleaning solution), which humectants limit the amount of evaporation, keeping the solution composition substantially constant. Some viscosity agents (such as propylene glycol) also function as humectants because they change the evaporation rate.

The ink-like cleaning solutions contain cleaners that specifically break down clogs. Also, in some embodiments, the ink-like cleaning solutions contain a small amount of pigment or dye so that it is possible to see test nozzle results on a paper media. The amount of pigment (fine particles) or dye (soluble substance) is not high enough to cause clogging, but high enough to see images printed on the media for testing (e.g., less than that in ink). As a pigment or dye, one or more of carbons, phthalocyanine dyes, azo dyes, and other pigments and dyes can be used in an amount of about 1% to about 10% (preferably about 2% to about 3%) relative to the total weight of the cleaning solution in some embodiments. In some embodiments, as the pigment, carbon black can be used, and as the dye, phthalocyanine blue or sulphonated azo dye can be used in the cleaning solution. The dye is preferable over the pigment since the dye does not generate precipitates and also the color need not be fade-resistant for a nozzle test.

In some embodiments, a cleaning solution is formulated with a specific viscosity and surface tension to be fired through ink nozzles just like ink used for the ink nozzles, and to be capable of breaking down ink deposits in the printing operation. Each print head nozzle itself acts like its own small pump to free deposits from inside. Since the cleaning solution has physical properties, especially viscosity and surface tension, substantially similar to those of ink used for the nozzles, the printer recognizes the cleaning solution as ink, and thus, no other pumps, solenoid valves, flow channels, control units or programs are necessary in some embodiments. Different types of cleaning solution are formulated for different ink types. The cleaning solution may be provided in a cartridge or in bulk format so that a user can clean his or her printer without modifying printer hardware. In some embodiments, ink chips are provided as necessary with the cleaning cartridge or bulk cleaner to make the printer operate as if it is still using ink. If the printer is programmed to accept the cleaning solution only when it is recognized as designated ink, then the appropriate chips are provided with the cartridge or bulk cleaner.

In some embodiments, a cleaning solution is specific to each type of ink. Also some inks within an ink type need a specific cleaning solution (e.g., T-shirt inks, eco-friendly inks, etc.). The purpose of adjusting the surface tension and viscosity is to allow the cleaning solution to work with the firing mechanism (thermal or piezo) as the delivery system. In some embodiments, to raise the viscosity of the cleaning solution, di-ethylene glycol or propylene glycol (or something similar such as glycerol) can be used singly or in combination. In some embodiments, to lower the surface tension of the cleaning solution, at least one compatible industrial surfactant such as 2-butoxyethanol, ethoxylated fatty ethyl alcohol, and fatty alkyl aminomide (or other surfactants such as triethanolamine) can be added. In some embodiments, at least one cleaning agent which can actually break down any ink deposits in the print head can be added, which is selected from the group consisting of dichloromethane, dimethyl sulfoxide (DMSO), N-methyl-2-pyrrolidone and some others such as gamma-butyrolactone In some embodiments, the viscosity agent (e.g., propylene glycol) can act to regulate the activity of the cleaning agent, inhibiting damage to the printing mechanism during the cleaning process. Also, in some embodiments, the surfactant acts as a wetting agent to help the cleaner penetrate dried deposits. In some embodiments, the viscosity agent, the surfactant, the cleaning agent, and the solvent are mutually exclusive. In some embodiments, a buffering agent is used to control pH and maintain a constant viscosity, which buffering agent includes, but is not limited to, trisodium citrate. Typically, the buffering agent itself does not regulate the activity of the cleaning agent. Typically, two main factors that work to regulate the activity of the cleaning agent are 1) the concentration of the cleaning agent in solution, and 2) the viscosity agent which increases the viscosity of the cleaning solution by using intermolecular attractive forces to keep other molecules (such as the cleaning agent) from moving away and interacting with other molecules (such as ink deposits or print head materials).

In some embodiments, the cleaning solution does not include a solvent base that is the same as the ink. For example, volatile organic compounds need not be used as a base for an ink-like cleaning solution for solvent inks. It is, however, necessary to make sure that reintroducing the ink back into the system does not create a precipitate due to the interaction of the cleaning solution with the ink. That would reclog the print head. The base solvent of the cleaning solution is typically an inert component that has a viscosity around that of water and that is compatible with the target ink. In some embodiments, as the solvent of the cleaning solution, diethylene glycol diethyl ether can be used for eco-solvent ink, 2-butoxyethyl acetate can be used for solvent ink, acrylates can be used for UV ink, and water can be used for water-based ink. In some embodiments, the same solvent, viscosity agent, surfactant, cleaning agent, and/or dye can be used for all types of ink, except the viscosity and surface tension are adjusted for each ink.

In some embodiments, the cleaning solution contains no components that are too dangerous to handle by users or ship via national or international carriers, or are flammable, corrosive or mutagenic chemicals. Also, in some embodiments, all the components of the cleaning solution, specifically the cleaning agent, are eco-friendly and biodegradable.

When the viscosity and surface tension of the cleaning solution are equivalent to those of the target ink, the cleaning solution can effectively clean the print head and ink tube (ink channel), since it acts as ink regarding physical properties. In some embodiments, the cleaning solution has substantially different properties from those of the target ink, except that the viscosity and surface tension of the cleaning solution are equivalent to those of the target ink. The viscosity and surface tension is equivalent when the print head is capable of printing using the cleaning solution in a manner similar to that using the corresponding ink. In some embodiments, the viscosity and surface tension of the cleaning solution are substantially the same as or similar to those of the corresponding ink. In general, the viscosity and surface tension of inks fall within the following ranges:

TABLE 1

| | | Surface tension |
|---|---|---|
| | Viscosity [cP] at 20° C. | [dyne/cm] at 20° C. |
| Eco-solvent ink | 5 to 7 (typically 6 to 7) | 22 to 35 (typically 25 to 26) |
| Solvent ink | 7 to 12 (typically 8 to 9) | 22 to 35 (typically 25 to 26) |
| UV ink | 5 to 25 (typically 9 to 10) | 22 to 35 (typically 25 to 26) |
| Water-based ink | 1.5 to 7 (typically 1.75 | 22 to 35 (typically 25 to 26) |
| | to 2 for Thermal type/5 | |
| | to 7 for Piezo type) | |

The numbers above include equivalents (e.g., approximate numbers), and the endpoints may or may not be included in the ranges.

The viscosity is selected depending on, e.g., the size of nozzles. For example, 7-12 picoliter nozzles (such as those for large format eco-solvent printers) use ink having a lower viscosity (e.g., within a lower half of the ranges shown in Table 1). Larger nozzles (e.g., 30-80 picoliters) (such as those used for grand format solvent printers) use ink having a higher viscosity (e.g., within an upper half of the ranges shown in Table 1). Typically, water based machines that use piezo print heads use ink having the same viscosity as that of the eco-solvent ink as shown in Table 1. Typically, thermal print heads use water-based ink having a lower viscosity as shown in Table 1. UV printers usually heat their ink to reduce the viscosity, and thus, the viscosity of ink in the cartridge or bulk ink tank is higher than that used in the print head as shown in Table 1.

Solvent inks typically contain volatile organic components, organic chemical compounds that have high vapor pressures, and pigments (which result in better fade-resistance than dyes). Eco-solvent inks (or mild solvent inks) typically contain solvents which can be used in enclosed spaces without specialized ventilation of the printing area, although they are not as safe as aqueous inks UV inks typically contain acrylic monomers with an initiator package. After printing, the ink is cured by exposure to strong UV-light. Water-based inks (or aqueous inks) typically contain a mixture of water, glycol, and dyes or pigments.

To measure the viscosity at room temperature (or at 20° C.), the falling ball method can be used in some embodiments. For example, a viscosity meter of falling ball type from Gilmont®, Thermo Fisher Scientific can be used. The viscosity can also be measured with a Zahn cup. This measures the viscosity by the time it takes for a measured volume of ink to drain from the cup. The surface tension at room temperature (or at 20° C.) can be measured with a Surface Tension Analyzer from Kimble Chase (Rochester, N.Y.) in some embodiments.

Knowing the composition of the target ink itself (pigment or dye) is helpful to formulate cleaning solutions. However, it has been found that components other than the ink itself are the major cause of the clog. For instance, an adhesion promoter in ink helps the ink stick to more types of media. However, it can cause the pigment to stick inside the print head, forming a clog. Further, with some inks, the adhesion promoter itself forms crystals in the nozzles, making a difficult clog. Companies that reformulate their inks to be more eco-friendly sometimes have an ink that clogs the print head much faster than normal. Also, customers like fast drying inks, but they usually clog in the print head too fast. In some embodiments, cleaning solutions are formulated using different cleaning agents so as to effectively attack the clogs. For instance, a cleaning solution is selected so as to break down the pigment itself or just destroy the binder so that it does not stick to anything. In some embodiments, after printing sample medium with candidate cleaning agents, print heads are recovered to see which cleaning solutions work best.

Typically, the cleaning agent is distinguished from a detergent which is a wetting agent or surfactant, rather than a cleaning agent. Detergents are soaps or surfactants which lower the surface tension of water or the like to penetrate oily stains, for example. A detergent can be defined as a surfactant which is in turn defined as having both hydrophobic and hydrophilic components. Printing ink already has a surfactant to lower the surface tension of the ink, but never contains a cleaning agent. In some embodiments, a cleaning agent added to the solution reverses the polymerization of the ink. When the ink dries or cures, it is polymerized or coagulated into a uniform closed cell layer. A detergent does not remove such a layer. However, a cleaning agent like a paint remover (containing dichloromethane) on a painted house changes the properties of the layer, making it unable to stick to the surface. The cleaning agents contained in the cleaning solution break down the polymerized or coagulated ink so that it does not stick to the print head and to itself.

In some embodiments, a ratio (by weight) of viscosity agent(s), surfactant(s), and cleaning agent(s) is essential to make an appropriate correct cleaning solution as follows (“% by weight” is % of the total weight of the component(s) relative to the total weight of the cleaning solution):

TABLE 2

| | Viscosity agent | | Cleaning agent | |
|---|---|---|---|---|
| | % by weight | Surfactant | % by weight | Ratio |
| | (V) | % by weight (S) | (C) | V/S/C |
| Eco-solvent | 5 to 45; | 1 to 10; | 5 to 25; | 5/1/5 to 4.5/1/2.5; |
| ink | typically 25 to | typically 3 to 5 | typically 5 to 15 | typically 8.33/1/1.66 |
| | 35 | | | to 7/1/3 |
| Solvent ink | 5 to 65; | 1 to 10; | 5 to 40; | 5/1/5 to 6.5/1/4; |
| | typically 25 to | typically 3 to 5 | typically 15 to | typically 8.33/1/1.66 |
| | 35 | | 25 | to 7/1/5 |
| UV ink | 10 to 65; | 1 to 10; | 5 to 50; | 10/1/5 to 6.5/1/5; |
| | typically 25 to | typically 3 to 5 | typically 25 to | typically 8.33/1/8.33 |
| | 35 | | 45 | to 7/1/9 |
| Water-based | 5 to 45; | 1 to 10; | 5 to 25; | 5/1/5 to 4.5/1/2.5; |
| ink | typically 15 to | typically 2 to 5 | typically 5 to 15 | typically 7.5/1/2.5 to |
| | 35 | | | 7/1/3 |

The numbers above include equivalents (e.g., approximate numbers), and the endpoints may or may not be included in the ranges.

In some embodiments, the cleaning solution can be produced by modifying a conventional cleaning solution (recovery solution) that is used for pumping through a print head using a recovery machine to recover them. The recovery solutions include, but are not limited to, “1DX, 2DX, 4DX, 5DX, and 6DX Eco-Solvent Print Head Recovery Solutions,” “1X, 2X, 4X, 5X, and 6X Solvent Print Head Recovery Solutions,” “1UV, 2UV, 3UV, 4UV, and 5UV Print Head Recovery Solutions,” and “1W, 3W, 4W, 5W, and 6W Waterbased Print Head Recovery Solutions” (manufactured and sold by Printhead 911, 1001 Avenida Pico, #C625, San Clemente, Calif. 92673, information on the formulae of these solutions is herein incorporated by reference). In some embodiments, the surface tensions and viscosities of these recovery solutions can be modified to work with printing mechanisms without using external pumps to pump solutions through the heads, by adjusting the viscosity and surface tension thereof while using the cleaning agent contained in the recovery solutions at appropriate concentrations which are different from those of the recovery solutions.

In some embodiments, the cleaning solutions comprise a cleaning agent which have not been used in the print head cleaning industry. For example, dichloromethane is used to remove paint in paint removers and remove caffeine from coffee. It is also used in the paper industry and the dry cleaning industry. In the correct concentration and with the proper regulating agents (e.g., viscosity agent), such chemicals can be used as effective cleaning agents in the cleaning solutions. On the other hand, for example, sulfuric acid is used in drain cleaning, oil refining, ore processing, lead acid batteries and more, and it is also a good cleaning agent for some industries. However, it is not suitable for the purpose of unclogging ink deposits since it does not effectively react with polymerized ink molecules. Typically, the following combinations are preferable in some embodiments:

TABLE 3

| | Concentration | | Concentration |
|---|---|---|---|
| Cleaning agent | (%) | Viscosity agent | (%) |
| Dichloromethane | 15-25 | Polyethylene glycol | 20-45 |
| Dimethyl | 25-40 | Propylene glycol | 20-45 |
| sulfoxide | | | |
| (DMSO) | | | |
| N-methyl-2- | 25-35 | Diethylene glycol | 10-40 |
| pyrrolidone | | | |

% is relative to the total weight of the cleaning solution;
The numbers above include equivalents (e.g., approximate numbers), and the endpoints may or may not be included in the ranges.

In order to preliminarily select candidates for cleaning solutions and evaluate the cleaning effect thereof and adverse interaction with ink, in some embodiments, 10% to 50% by weight of the cleaning solution is mixed in the ink relative to the total weight of the mixture, and the mixture is left for a week while checking it daily, thereby evaluating the candidate cleaning solution prior to a test using a printer.

Some of the formulas require a procedure to manufacture the cleaning solution, such as reactions, filtration, heating, etc, particularly when the chemicals are not highly pure, generating particles. For instance, when the chemicals are not highly pure, the chemicals are mixed in a solution using a warm recirculating bath, and then are allowed to react over the course of 6 hours so that a side reaction takes place and forms a precipitate as a by-product (impurities). The solution is then passed through a 20-micron filter for 30 minutes and then through a 5-micron filter for an additional 30 minutes. A pressure of 100 psi can be used along with heat to break down the precipitate so that it becomes small enough to react again and form the main product. The resulting solution is substantially precipitate free or particle free.

The cleaning solution can be contained in a cartridge which can be plugged into a printer or it can be supplied in bulk. A user can fill a cartridge with the cleaning solution, or a cartridge filled with the cleaning solution can be supplied to a user by a cleaner provider, an ink provider, or a printer manufacturer. One or more cleaning solutions can be supplied with the corresponding inks as a set.

In some embodiments, the printer control unit obtains information from an ink chip to identify the ink type, color, and volume of ink so that only the right type and color of ink can be used when it has the right volume. In some embodiments, in order to use a cleaning solution as ink for the printing mechanism, a cartridge is created so that the cleaning solution is identified as ink and can mimic ink for the printer. Even if the same cleaner solution is used in many eco-solvent printers, it is necessary to program the ink chips for each printer. For instance, even if the same solution is used on a Mimaki or Roland printer, for example, each ink chip needs to be programmed for each printer model, ink type and color. That way the users can buy a yellow cleaning cartridge, for example, for their Roland printer with Ecomax ink. The cleaning solution is not yellow, but the printer operates as if it is yellow ink because the chip is programmed correctly. Otherwise, the printer rejects the cartridge as ink. In some embodiments, in order to set an ink chip for the cleaning solution, a chip charger system which is sold by Vladimir can be used. It allows for taking a programmable chip and placing it into a USB programmer. A program is then run to program the chip with the printer, ink type and color of interest. Most ink cartridges come with preprogrammed chips from the factory.

Once the cleaner is installed into the printer, the user places an absorbent media on a platen or the printer can be programmed to fire nozzles into the docking station. The user then prints specific images through the RIP to print dots through the nozzles as if it is ink, and clean the nozzles. In the alternative, a separate program running on an external computer or in the printer itself can print patterns through the printer to clean the print head nozzles. In some embodiments, the user/program may print dots using different firing frequencies and volumes to effectively clean the print head.

In some embodiments, a small amount of color is added to the cleaner to help the user see the results of a nozzle test on the absorbent media. In some embodiments, dyes are used rather than pigments because dyes do not generate precipitates and also the color need not be fade-resistant.

Once there is an acceptable nozzle test, the user replaces the cleaning cartridge or bulk cleaner with the original ink cartridge or bulk ink. After a few ink fills, the user can go back to regular printing.

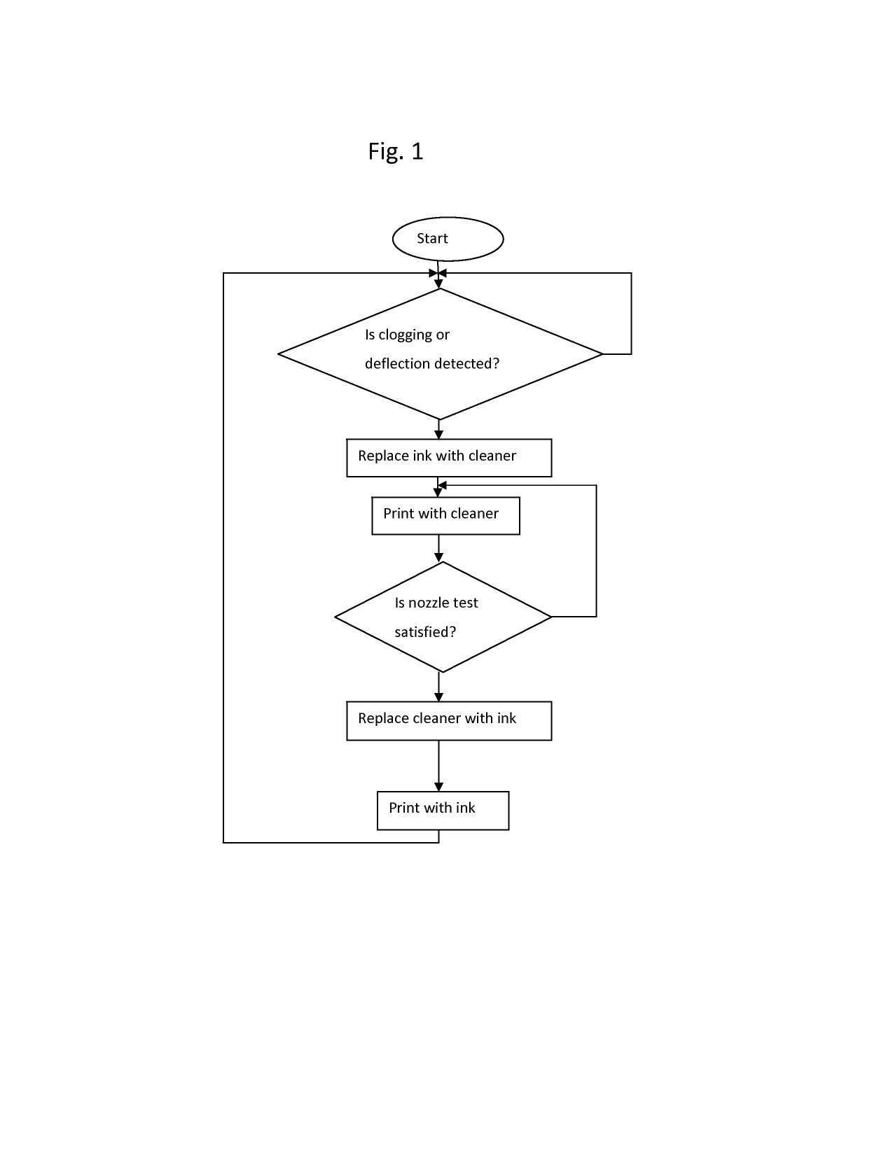

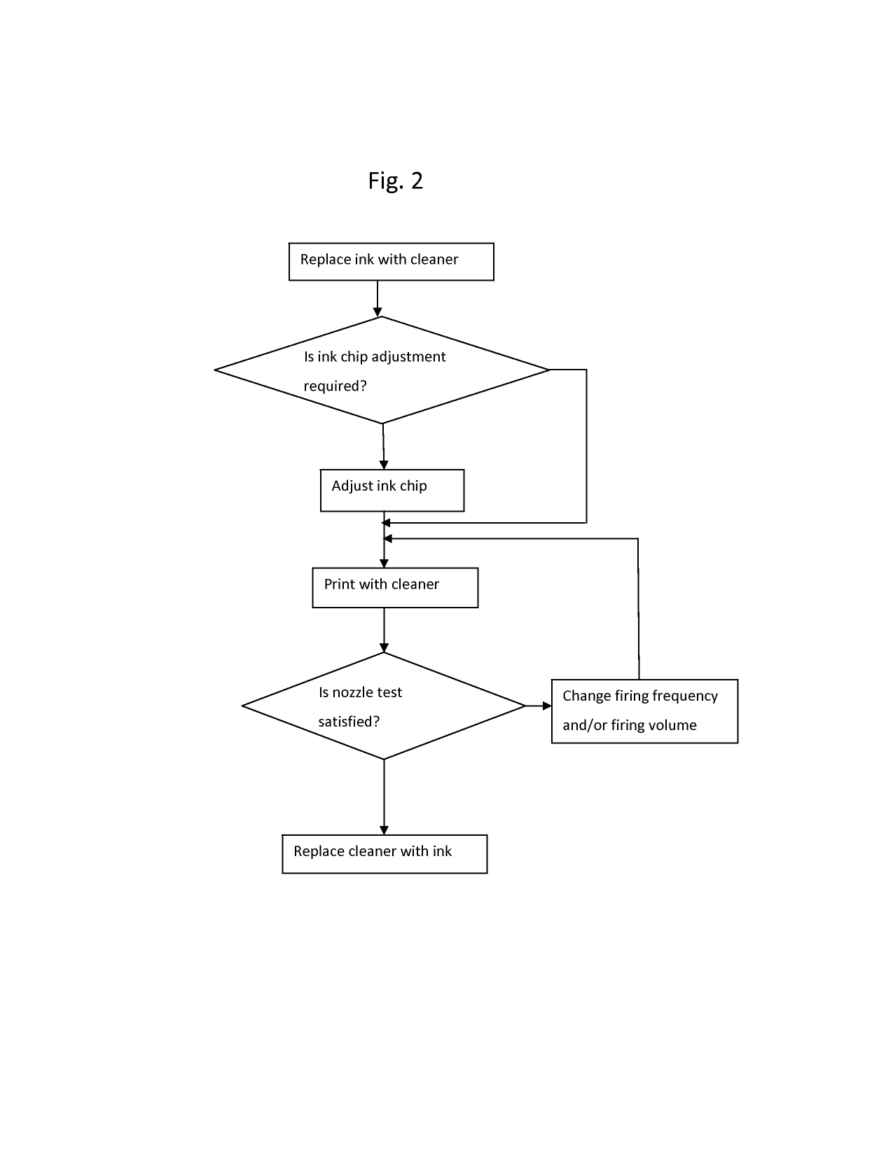

An aspect of the present invention, among other aspects, will be explained with reference to the figures. FIG. 1 is a flow chart illustrating a cleaning method according to an embodiment of the present invention. FIG. 2 is a flow chart illustrating a part of the cleaning method according to an embodiment of the present invention. The embodiments are not intended to limit the present invention.

When the disclosed method starts, first, it is determined whether clogging or deflection is detected in any nozzles of a print head (S10). This step can be accomplished using a built-in sensor installed in each nozzle of the print head, and a printer control unit receives signals from the sensors, notifying a user of the occurrence of clogging or deflection of any nozzles. Alternatively, step S10 can be accomplished by a user's observation of actual print on a media. Alternatively, step S10 can be accomplished by time, i.e., cleaning can be timed and can periodically be initiated. In some embodiments, step S10 is omitted, i.e., regardless of the status of actual clogging or deflection of any nozzles, a user can initiate cleaning of the nozzles as a preventive step so that it is possible to avoid clogging or deflection of the nozzles.

If at least one nozzle of the print head is identified as a nozzle in need of cleaning due to deposits of ink in step S10, a supply of the ink to the nozzles is discontinued. The ink supply can be provided using an ink cartridge or in bulk, depending on the printer. A proper cleaning solution, which is any of the disclosed cleaning solutions, is selected for the ink. The cleaning solution has a viscosity and surface tension equivalent to those of the ink. The cleaning solution is then supplied to the identified, clogged or deflected nozzle (or a nozzle for preventive cleaning) without removing the print head from the printer (S11). In some embodiments, the print head can be removed and installed in a testing device to perform step S11. The cleaning solution is then caused to pass through the nozzle under conditions equivalent to those for printing (S12). The firing frequency, the DPI, and the droplet size can be controlled in a manner which is the same as or substantially similar to that for the ink by the RIP or a software program. In some embodiments, it is not necessary for the print head to print on a paper media from the beginning to unclog the nozzles or to confirm completion of unclogging. The cleaning solution can stay in a capping station and fire nozzles until the cleaning matures to a nozzle test. The capping station is typically disposed immediately downstream of the nozzle plate for a conventional recovery process using a conventional cleaning solution, to receive the conventional cleaning solution. Thus, in some embodiments, the cleaning solution need not contain a dye or pigment until the cleaning matures to a nozzle test (e.g., there are multiple cleaning solutions, and only a finishing cleaning solution contains a dye or pigment). That way it is possible to conserve the paper media. In some embodiments, the cleaning solution contains a dye or pigment, and thus, a user can observe an image as a result of printing using the cleaning solution. Next, it is determined whether cleaning is complete, or it is determined whether a nozzle test is satisfied (S13). The nozzle test can be conducted by the user's observation or by the built-in sensor. If the cleaning is complete, the cleaning solution is replaced with the ink by replacing the cleaning cartridge or bulk cleaner with the original ink cartridge or bulk ink (S14). After a few ink fills, the user can go back to regular printing (S15). The term “a fill” refers to filling the print head with ink (or cleaning solution). Large format printers have a process to bring ink from the cartridge to the print head. The tubing between the cartridge and the print head can be from 3′ to 10′ long. The machine uses peristaltic pumps to create suction from the cap station through the print head and draws the ink from the cartridge to the print head. A “fill” can be selected from a control panel of the printer, and the process begins to draw ink to the print head. This process typically needs to be repeated from 3-7 times to get the ink all the way to the print head. If the print head is partially clogged, it can take several more times because some of the nozzles are clogged and the ink can only be drawn up through nozzles that are not clogged.

Many printers use specific ink and in order to make sure that the proper ink is used, an ink chip is used. The ink chip also stores information on volume, and thus, even if the ink is correct, if the cartridge is empty, the printer does not accept the cartridge. Thus, if an ink chip is used in the printer (S21), the ink chip must be adjusted (S22) so that the print head can print as if the cleaning solution is the ink. In some embodiments, the printer is configured to accept a cleaner solution cartridge which has a specific cleaning solution chip. The cleaning solution is then caused to pass through the nozzle under conditions equivalent to those for printing (S23), and it is determined whether the nozzle test is satisfied (S24). The cleaning solution passes through as if it is the ink in S23. If the nozzle test is not satisfied, in some embodiments, the firing frequency and/or firing volume are/is changed (S25), and S23 is repeated to unclog the nozzle so that the nozzle test is satisfied. For example, the firing frequency may be about 1,000 Hz to about 7,000 Hz, typically about 1,000 Hz to about 4,000 Hz, depending on the type of print head. In some embodiments, by increasing the firing frequency by about 50% to about 100%, action of unclogging or removing deposits can be promoted. For example, the firing volume may be about 3 picoliters to about 80 picoliters typically about 7 picoliters to about 30 picoliters, depending on the type of print head. In some embodiments, by increasing the firing frequency by about 50% to about 100%, action of unclogging or removing deposits can be promoted. Alternatively, the DPI may be adjusted. The DPI may be about 360 to about 1440, typically about 360 to about 720. In some embodiments, by increasing the DPI by about 50% to about 100%, action of unclogging or removing deposits can be promoted.

It should be noted that different printers use different ways to place dots on media. Some printers use carriage speed and firing frequency to create different modes of printing. For instance, a draft mode is likely to set a fast carriage speed and a high firing rate. A high quality mode is likely to set a slow carriage speed and a lower firing rate. Some printers use a combination of carriage speed, firing frequency, and dot size to create different DPI's. A skilled artisan in the art could readily manipulate the firmware to adjust the carriage speed, firing rate, and dot size for effective nozzle cleaning using the cleaning system according to any of the disclosed embodiments.

If the print head is completely clogged, the above cleaning processes alone may not be sufficient. In some embodiments, prior to the above cleaning processes, by using a piece of lint-free cloth glued (with a special heat-activated glue) to a thin plastic backing, which cloth is soaked with a cleaning solution, the print head can be treated by carefully sliding the cloth underneath the print head and keeping it in position for a while to partially unclog the nozzles, and then a fill of the cleaning solution can start.

According to the embodiments described above or other embodiments, one or more of the following advantages can be obtained: The life of the print head can significantly increase, saving cost. No hardware modification is necessary to use the cleaner. No recalibrations need to be performed on the printer because the print head is not removed. Printers are renewed and reused instead of being disposed of in landfills. Cleaner can be used as a preventive maintenance device to keep the printer running in top condition and avoid costly breakdowns. Stored dried-out print heads/printers can be restored to working condition. The tubing from the ink cartridge to the print head is also cleaned, inhibiting deposits from building up in the tubing and clogging the print head later.

As described above, in some embodiments, the printer is made to accept the cleaning solution as the ink and operate as if the print head is still printing, by modifying an ink chip programmed for the printer, ink type and ink color. The above can be accomplished by configuring a printer itself to accept the cleaning solution and put a recovery procedure in its firmware (or external software program). Also, a cleaning system using the cleaning solution can be integrated into a printer by having one or more additional cleaning cartridges with internal firmware or an external program to run the cleaning procedure. In some embodiments, by using automatic or manual valves, the printer can switch off the ink and allow the cleaner to enter the print head. Further, as described above, in some embodiments, the cleaning solution is contained in a cartridge, but in other embodiments, the cleaning solution can be provided in bulk and the users can refill their own cartridges or use the bulk cleaner in their bulk ink system. Additionally, in some embodiments, ink and cleaning solutions can be integrated into the same cartridge (separately stored) configured to work with a printer.

### EXAMPLES

The embodiments will be explained with respect to preferred embodiments. However, the preferred embodiments are not intended to limit the present invention.

In the disclosure, the clogging is measured by a nozzle test using the printer to see how many nozzles are firing. The test prints a short line segment to show the printer operator that each nozzle is firing. For example, the print head is 75% clogged, when the test shows that about ¾ of the nozzles are not firing and about ¼ of the nozzles are firing.

### Example 1

A Roland Eco-Solvent Printer was used for printing for an extended time period, resulting in a 70% clogged print head for black and a 25% clogged print head for cyan. The eco-solvent black ink had a viscosity of 5.75 cP (at 20° C.) and a surface tension of 24.5 dynes/cm (at 20° C.). The eco-solvent cyan ink had a viscosity of 5.8 cP (at 20° C.) and a surface tension of 24.5 dynes/cm (at 20° C.).

A cleaning solution for black ink and a cleaning solution for cyan ink were prepared based on the formulae shown below.

TABLE 4
Cleaning solution for black & cyan ink

| Category | Component | Content (% by weight) |
|---|---|---|
| Base solvent | Diethylene glycol | 38 |
| | diethyl ether | |
| Viscosity agent | Propylene Glycol | 33 |
| Buffer agent | None | 0 |
| Industrial surfactant | Silicone Surfactant | 4 |
| Cleaning agent | Dimethyl sulfoxide | 25 |
| Pigment or dye | Carbon Black | <1 |

| | |
|---|---|
| Viscosity [cP] | 5.5 |
| Surface tension [dynes/cm] | 24.7 |

A printer cartridge (200 cc) for a Roland Eco-Solvent Printer was loaded with cleaning solution. An assortment of chips was prepared by a chip charger system sold by Vladimir so that the cartridge could be plugged into different color slots of the printer. Cleaning operation was initiated with the black print head by putting the black chip on the cartridge and plugging it into the slot. The Roland printer accepted the cartridge as black ink. A document was then created consisting of a black rectangle 34 inches wide by 24 inches long using only black ink. A simple printer profile was then created for the postscript RIP that would not change the color and just print the black cartridge only. Most regular color profiles would change the black to include the other colors to make the black richer. Here, only black ink was printed. 5 ink fills (i.e., cleaning solution fills) were conducted to get the cleaning solution from the cartridge to the print head. A nozzle test was conducted after each fill to make sure the print head was still clogged. It took 5 fills before the solution reached the print head. Butcher paper was then loaded into the printer and the RIP was set to print the document at 360 dpi. The solution was dyed light black and some improvement was observed after running the file twice on the nozzle test. The dpi was then switched to 720 dpi (which prints twice as much ink as 360 dpi). After printing the file 2 more times, a nozzle test was conducted and all the nozzles were made to fire. The file was then printed one more time and it was confirmed that all the nozzles were firing perfectly straight. 6 more ink fills were then conducted to allow the fluid to clean out the ink tubes. Then the original black cartridge was loaded into the machine and 5 more ink files were done to load the original ink back into the printer. A nozzle test and another document printing confirmed that all nozzles were firing perfectly straight.

The chip was then switched in the cleaning cartridge to cyan and placed into the cyan slot. The same procedure was repeated with the cyan (and a cyan rectangle) at 720 dpi and all the nozzles were restored to firing after printing the file once. The same ink fill procedure was used to clean out the tubes and the original cyan ink cartridge was placed back into the printer. After 5 ink fills, the inks were back in the printer. Another nozzle test was conducted and it was confirmed that both print heads were working like new. A full color banner was printed to make sure the print heads remained in good condition. The banner looked good without any banding.

### Example 2

An HP Water-based Printer had 50% clogged Magenta print head. Although using the built-in cleaning function, the print head still remained clogged. The water-based ink had a viscosity of 2 cP (at 20° C.) and a surface tension of 24.7 dynes/cm (at 20° C.).

A cleaning solution for the magenta ink was prepared with the formula listed below.

TABLE 5
Cleaning solution for magenta ink

| | | Content |
|---|---|---|
| Category | Component | (% by weight) |
| Base solvent | Water | 60 |
| Viscosity agent | Glycerol | 12 |
| Industrial surfactant | 2,4,7,9-Tetramethyl-5- | 5 |
| | decyne-4,7-diol ethoxylate | |
| | (10) | |
| Cleaning agent (functioning | Sodium hydroxide | 20 |
| also as Buffer Agent) | | |
| Pigment or dye | Sulphonated azo dye | 2 |

| | |
|---|---|
| Viscosity [cP] | 1.75 |
| Surface tension [dynes/cm] | 25.8 |

Approximately 100 ml of cleaning solution was placed into an empty bulk ink bottle used in a bulk ink system installed on the printer. A chip resetting mechanism was used to reset the ink chip so that the printer would behave as if a 100% cartridge of magenta ink was installed. The printer was given an ink fill command to fill the print head with the solution. The machine was given a solid magenta only file and programmed to print an image at 600 dpi in a production mode. The print size was a 2′×3′. After the printer finished the print and it was inspected, the first 3 inches of print showed banding, but the rest of the print showed no banding at all. A nozzle test was performed and all the nozzles were firing. The solution was removed from the bottle and replaced with magenta ink. The machine was set to perform 2 ink refills to remove the solution from the print head and replace it with fresh ink. Another nozzle test was performed and it verified that the print head was recovered.

### Comparative Example 1

An old used print head for the same printer used in Example 2 was placed into the printer and tested. A nozzle test indicated that the print head was 80% clogged. The color of the ink was black. The water-based ink had a viscosity of 2 cP (at 20° C.) and a surface tension of 24.7 dynes/cm (at 20° C.).

A cleaning solution for the black ink was prepared with the formula listed below. The cleaning agent was omitted from the formula.

TABLE 6
Cleaning solution for black & cyan ink

| | | Content |
|---|---|---|
| Category | Component | (% by weight) |
| Base solvent | Water | 63 |
| Viscosity agent | Glycerol | 20 |
| Industrial surfactant | 2,4,7,9-Tetramethyl-5- | 5 |
| | decyne-4,7-diol ethoxylate | |
| | (10) | |
| Buffer Agent | Sodium citrate | 10 |
| Pigment or dye | Sulphonated azo dye | 2 |

| | |
|---|---|
| Viscosity [cP] | 1.75 |
| Surface tension [dynes/cm] | 26 |

Approximately 100 ml of cleaning solution was placed into an empty bulk ink bottle used in a bulk ink system installed on the printer as before. The printer was given an ink fill command to fill the print head with the solution. The machine was given a solid black only file and programmed to print an image at 600 dpi in a production mode. The print size was a 2′×3′. After the printer finished the print and it was inspected, the entire print showed very little improvement. A nozzle test was performed and the result showed that a few nozzles had unclogged, but 75%-80% of the nozzles were still clogged. The printer was given the same document to print 5 times. All 5 prints were inspected with the same results. No print head improvement was seen. Without the cleaning agent, the experiment was unsuccessful.

It will be understood by those of skill in the art that numerous and various modifications can be made without departing from the spirit of the present invention. Therefore, it should be clearly understood that the forms of the present invention are illustrative only and are not intended to limit the scope of the present invention.

We claim:

1. An ink-like cleaning solution for cleaning an inkjet print head having deposits of ink, installed in an inkjet printer, comprising:
at least one viscosity agent for adjusting the viscosity of the ink-like cleaning solution;
at least one surfactant for adjusting the surface tension of the ink-like cleaning solution;
at least one cleaning agent for breaking down the deposits of ink; and
at least one solvent miscible with the ink, in which the viscosity agent, the surfactant, and the cleaning agent are dissolved or dispersed,
wherein the viscosity and the surface tension of the ink-like cleaning solution are equivalent to those of the ink used for printing with the inkjet print head such that the inkjet print head can print on a media using the ink-like cleaning solution under conditions for printing.

2. The ink-like cleaning solution according to claim 1, further comprising a dye for indicating printing results on the media.

3. The ink-like cleaning solution according to claim 1, wherein the viscosity and surface tension are equivalent to those of the ink selected from the group consisting of water-based ink, solvent ink, eco-solvent ink, UV ink, and T-shirt ink.

4. The ink-like cleaning solution according to claim 1, wherein the cleaning agent is selected from the group consisting of dichloromethane, dimethyl sulfoxide (DMSO), and N-methyl-2-pyrrolidone.

5. The ink-like cleaning solution according to claim 1, wherein the viscosity agent is selected from the group consisting of diethylene glycol and propylene glycol.

6. The ink-like cleaning solution according to claim 1, wherein the surfactant is selected from the group consisting of 2-butoxyethanol, ethoxylated fatty ethyl alcohol, and fatty alkyl aminomide.

7. The ink-like cleaning solution according to claim 1, further comprising a buffer for controlling pH.

8. The ink-like cleaning solution according to claim 1, which is substantially free of humectants which keep the solution from evaporating and of adhesion promoters which promote droplets from the print head to stick to a media.

9. The ink-like cleaning solution according to claim 1, which is stored in a cartridge adapted to be plugged into the printer as if the cartridge is an ink cartridge.

10. The ink-like cleaning solution according to claim 2, which consists essentially of the at least one viscosity agent, the at least one surfactant, the at least one cleaning agent, the at least one solvent, and the dye.

11. A container containing the ink-like cleaning solution of claim 1.

12. The container according to claim 11, which is provided with an ink chip which is a circuit board communicating with a printer control unit to provide the printer control unit with information corresponding to ink type, color, and/or volume information.

13. The container according to claim 11, which is a cartridge adapted to be plugged into a printer.

14. The container according to claim 13, which is provided with an ink chip which is a circuit board attached to the container and communicating with a printer control unit to provide the printer control unit with information corresponding to ink type, color, and/or volume information.

15. A method for cleaning of an inkjet print head having deposits of ink, comprising:
(i) providing the ink-like cleaning solution of claim 1 which has a viscosity and surface tension equivalent to those of the ink;
(ii) supplying the ink-like cleaning solution to at least one nozzle of the print head which is in need of cleaning due to the deposits of ink; and
(iii) causing the ink-like cleaning solution to pass through the nozzle under conditions equivalent to those for printing, thereby cleaning the nozzle.

16. A method for in-situ cleaning of an inkjet print head installed in an inkjet printer and having deposits of ink, comprising:
(i) identifying at least one nozzle of the print head which is in need of cleaning due to deposits of ink;
(ii) after discontinuing a supply of ink to the nozzle, providing the ink-like cleaning solution of claim 1 which has a viscosity and surface tension equivalent to those of the ink;
(iii) supplying the ink-like cleaning solution to the nozzle without removing the print head from the printer; and
(iv) causing the ink-like cleaning solution to pass through the nozzle under conditions equivalent to those for printing, thereby cleaning the nozzle.

17. The method according to claim 16, further comprising, after step (iv), printing an image on a medium using the ink-like cleaning solution to determine whether cleaning is complete, wherein the ink-like cleaning solution contains a dye.

18. The method according to claim 16, further comprising, prior to step (iii),
setting an ink chip for printing using the ink-like cleaning solution, which ink chip is a circuit board communicating with a printer control unit to provide the printer control unit with information corresponding to ink type, color, and/or volume information; and
causing the printer control unit to accept the ink chip so as to allow printing.

19. The method according to claim 16, further comprising, after step (iv),
determining whether cleaning is complete, and
if it is not complete, repeating steps (iii) and (iv).

20. The method according to claim 19, wherein step (iv) is repeated after changing frequency and/or volume of the ink-like cleaning solution ejected from the print head.
